(19) United States
(12) Patent Application Publication
(10) Pub. No.: US 2024/0262319 A1
(43) Pub. Date: Aug. 8, 2024

(54) Roller Assembly for Automatic Conveyorized Car Wash

(71) Applicant: Car Aroma, Inc., Wilmington, CA (US)

(72) Inventor: Daniel Umbrell, Wilmington, CA (US)

(21) Appl. No.: 18/633,171

(22) Filed: Apr. 11, 2024

Related U.S. Application Data
(63) Continuation of application No. 18/371,443, filed on Sep. 22, 2023, now abandoned.
Application No. 18/371,443 is a continuation of application No. 17/015,051, filed on Sep. 8, 2020, now abandoned.

(51) Int. Cl. B60S 3/00

(52) U.S. Cl. CPC B60S 3/004

(57) ABSTRACT

A roller assembly for an automatic conveyorized car wash is provided. In preferred embodiments, the roller assembly includes has a body, a tube, and a rod, wherein the rod is affixed to an inner surface of the tube. The assembly further includes at least first and second rollers, wherein the first roller is slid over (and rotates about) the tube, and the second roller is slid over (and rotates about) the rod. Because the rod is offset with respect to the tube, the rollers are as well (i.e., the first roller has an axis of rotation that is offset from the second roller's axis of rotation). This allows the first roller to only touch a first surface (e.g., an upper surface of a track) and the second roller to only touch a second surface (e.g., a vehicle's tire).

### BACKGROUND OF THE INVENTION

### 1. Field of the Invention

The present invention is directed toward an automatic conveyorized car wash, and more particularly, to an apparatus (e.g., roller assembly, etc.) for moving a vehicle through the car wash, the apparatus having at least first and second rollers, wherein the first roller has a rotational axis that is offset from a rotational axis of the second roller, thereby allowing the first roller to come into contact with a first surface (e.g., an upper surface a track within the car wash) and the second roller to come into contact with a second surface (e.g., a vehicle's tire).

### 2. Description of Related Art

Conveyorized automatic car washes have been around since the 1940s. In general, a vehicle is driven to the entrance of a tunnel-like building (see FIG. 1 at 10), where a pre-paid code (or the like) is entered. The vehicle 110 is then guided (e.g., by the driver) into the building and onto a track 100. At a designated location, the driver is instructed to stop the vehicle 110 (e.g., via a stoplight), place the vehicle 110 in neutral, release all brakes, and refrain from steering. At this time, at least one roller comes up (or is otherwise positioned) behind at least one tire (see FIG. 2 at 140, 150). The roller is moved along the track (e.g., via a chain-driven conveyor system), through a plurality of “zones” (e.g., presoak, wheel cleaning, high-pressure, friction (e.g., brushes, wraps, cloth strips, etc.), rinse, care (e.g., wax, protectant, clear coat, etc.), “spot free” rinse, drying, etc.) (see FIG. 1 at 120, 130), to a finish location.

As shown in FIGS. 2A-C, there are several types of car wash conveyor system. For example, an over/under conveyor system 100A is illustrated in FIG. 2A. In this system, a chain 106 (or the like), located underneath the floor 102, is connected to a roller assembly via a linkage assembly 108A. When the conveyor is activated, the chain 106 pulls the linkage assembly forward, resulting in the roller 152 rotating in a clockwise direction, traveling over the floor 102 (or a track portion thereof) from a starting location to a finish location. The roller assembly is subsequently returned to the starting location via a vertical loop within the floor (not shown).

By way of another example, a second over/under conveyor system 100B is illustrated in FIG. 2B. This system operates similarly to the one shown in FIG. 2A. There are two primary differences: (1) the linkage assemblies (108A, 108B) are structurally different; and (2) the second system includes a second roller 150B that comes into contact with (and travels over) an underside 104 of the floor 102 when the conveyor is activated.

A surface conveyor 100C is illustrated in FIG. 2C. In this system, a chain 106 (or the like), located above the floor 102 (e.g., in a wall 160), is connected to a roller assembly via a linkage assembly 108C. When the conveyor is activated, the chain 106 pulls the linkage assembly forward, resulting in the roller 150 rotating in a clockwise direction, traveling over the floor 102 (or a track portion thereof) from a starting location to a finish location. The roller assembly is subsequently returned to the starting location via a horizontal loop above the floor (not shown). Because the conveyor is located aboveground, it may require a pivot (P) for the roller to remain horizontal, or parallel to the floor/track.

In either system, the roller (152, 152A) is configured to rotate clockwise when the conveyor is activated. This is because the roller (152, 152A) is traveling over an upper surface of the floor. However, as shown in FIG. 1B, a second roller 154, which is configured to come into contact with the vehicle's tire 140, is configured to rotate in a counterclockwise direction when the conveyor is activated. This is because it is in contact with the vehicle's tire, which is rotating in the opposite direction. Thus, the first and second rollers (152, 154) must be independent from one another. Further, each one should be configured to only come into contact with a corresponding surface (e.g., the first roller should only come into contact with a first surface and the second roller should only come into contact with a second surface).

FIG. 3 shows an example of a prior art roller assembly having a first roller (B) and a second roller (C), where each roller is independent from the other and has a diameter that allows it to only come into contact with a corresponding surface (e.g., one diameter is configured to come into contact with a track and the other diameter is configured to come into contact with a tire). As can be seen, such an assembly is quite complex and requires many moving parts, all of which will need to be maintained and/or replaced during the life of the conveyor (e.g., bushing (A), first roller (B), second roller (C), carrier link (D), chain pin (E), chain side bar (F), hex bolt (G), hex nut (H), flat washer (I), and flat washer (J)).

Further, because the first and second rollers have different diameters, different roller will need to be stocked depending on which rollers need to be replaced. This become more problematic if different roller assemblies are required (e.g., when using different conveyor systems, such as over/under and surface conveyors). In fact, some prior art roller assemblies require bushings (e.g., offset bushings) that further wear out, requiring additional stocking of replacements parts and continuous maintenance— maintenance that often requires removal and disassembly of the entire roller assembly.

Thus, there is a need for a new and improved car wash roller assembly that addresses at least some of the foregoing drawbacks. For example, a design that has fewer components, requires less maintenance, provide interchangeability between rollers, and/or provides interchangeability between different roller assemblies for different conveyor types, would be advantageous. The new and improved assembly should ensure (i) roller independence, (ii) that a first roller only comes into contact with a first surface (e.g., an upper surface of a track), and (iii) that a second roller only comes into contact with a second surface (e.g., the vehicle's tire), and should preferably do so using offsets between a first rotational axis (e.g., of the first roller) and a second rotational axis (e.g., of the second roller).

### SUMMARY OF THE INVENTION

The present invention is directed toward an automatic conveyorized car wash, and more particularly, to an apparatus (e.g., roller assembly, etc.) for moving a vehicle through the car wash, the apparatus having at least first and second rollers, wherein the first roller has a rotational axis that is offset from a rotational axis of the second roller, thereby allowing the first roller to come into contact with a first surface (e.g., an upper surface a track within the car wash) and the second roller to come into contact with a second surface (e.g., a vehicle's tire).

Preferred embodiments of the present invention include a roller assembly having at least a first and second roller and a linkage assembly configured to connect the roller assembly to a conveyor—the linkage assembly being configured to mate with a specific conveyor type (e.g., over/under, surface, etc.).

In a one embodiment of the present invention, the roller assembly includes a body having a proximate end and a distal end, wherein the proximate end is connected to a metal tube. A metal rod is affixed (e.g., welded, etc.) to an inner surface of the tub in an offset fashion. The roller assembly further includes first and second rollers that are configured to mate with (e.g., slide over) a first end of the tube and rod, respectively. In operation, this allows the first roller to rotate about the tube and the second roller to rotate (independently) about the rod. Not only are the rollers independent, but because the rod is offset with respect to the tube, the rollers are as well (i.e., the first roller has an axis of rotation that is offset from the second roller's axis of rotation). This allows the first roller to only touch (i.e., come into contact with) a first surface (e.g., an upper surface of a track) and the second roller to only touch (i.e., come into contact with) a second surface (e.g., a vehicle's tire).

In alternate embodiments, the roller assembly may further include a second pair of rollers configured to slide over and rotate about a second end of the tube and rod, respectively. In order to reduce friction between the first and second rollers, the assembly may further include at least one washer. In another embodiment, the assembly may further (or alternatively) include at least one other washer for securing the second roller(s) in place (e.g., preventing the second roller(s) from sliding off the rod).

In another embodiments, the roller assembly may further include a third pair of rollers configured to slide over and rotate about a shaft connected to a distal end of the body. As discussed above, at least one washer may be used to secure the third pair of rollers in place (e.g., preventing the third pair of rollers from sliding off the rod). In either embodiment, the roller assembly is preferably connected to (or includes) a linkage assembly that is designed to mate with a certain type of conveyor system (e.g., over/under, surface, etc.), or chain-driven portion thereof.

A more complete understanding of a roller assembly for an automatic conveyorized car wash will be afforded to those skilled in the art, as well as a realization of additional advantages and objects thereof, by a consideration of the following detailed description of the preferred embodiment. Reference will be made to the appended sheets of drawings that will first be described briefly.

### BRIEF DESCRIPTION OF THE DRAWINGS

FIGS. 1A-B depict a traditional automated conveyorized car wash that is configured to move a vehicle through the car wash via a track;

FIGS. 2A-C depict different types of conveyor systems for car washes (e.g., over/under and surface) and different types of roller assemblies that can be used therewith;

FIG. 3 depicts a prior art roller assembly having different diameter wheels, where a first set of wheels are configured to come into contact with a first surface (e.g., an upper surface of the track) and a second set of wheels are configured to come into contact with a second surface (e.g., an outer surface of a tire);

FIGS. 4 and 8 provide exploded views of a roller assembly in accordance with a first embodiment of the present invention;

FIGS. 5A-C, 6, 7, 9, and 10 provide other views of the roller assembly depicted in FIGS. 4 and 8, including side views (FIGS. 5A-C and 10), assembled views (FIGS. 7 and 9) and a view illustrating a corresponding linkage assembly (FIG. 6);

FIGS. 11A-B and 12 provide views of a roller assembly in accordance with a second embodiment of the present invention;

FIGS. 13A-B and 14A-B provide views of a roller assembly in accordance with a third embodiment of the present invention; and

FIG. 15 shows at least a portion of a roller assembly in accordance with an alternate embodiment of the present invention.

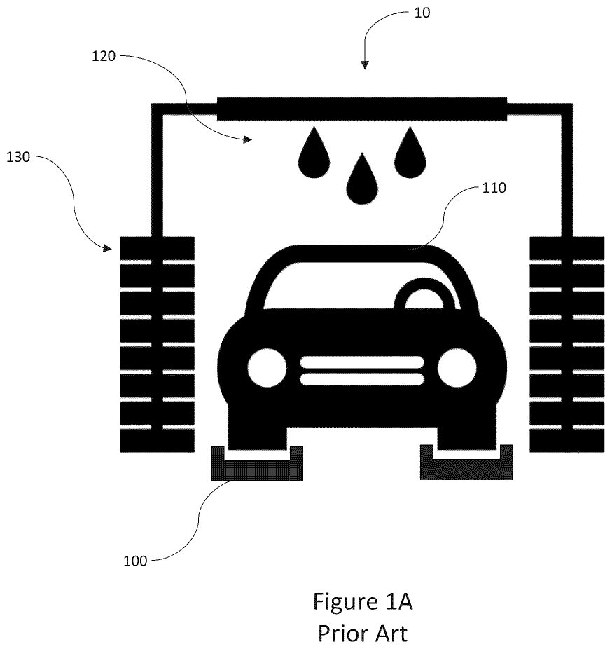

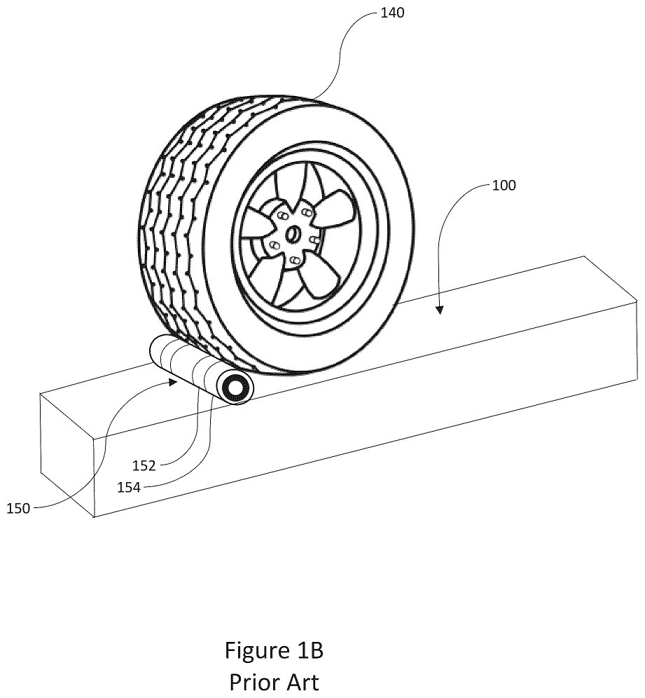

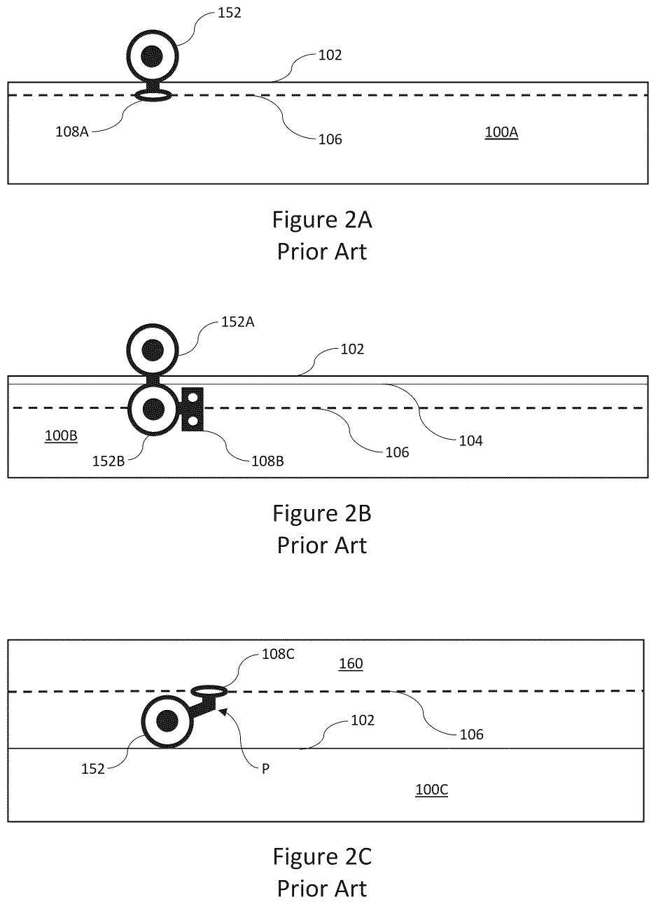

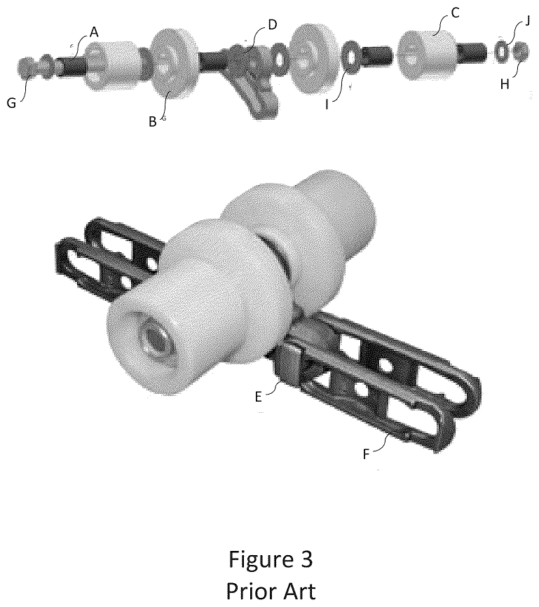

### DETAILED DESCRIPTION OF THE PREFERRED EMBODIMENT

The present invention is directed toward an automatic conveyorized car wash, and more particularly, to an apparatus (e.g., roller assembly, etc.) for moving a vehicle through the car wash, the apparatus having at least first and second rollers, wherein the first roller has a rotational axis that is offset from a rotational axis of the second roller, thereby allowing the first roller to come into contact with a first surface (e.g., an upper surface a track within the car wash) and the second roller to come into contact with a second surface (e.g., a vehicle's tire). Preferred embodiments of the present invention include a roller assembly having at least a first and second roller and a linkage assembly configured to connect the roller assembly to a conveyor—the linkage assembly being configured to mate with a specific conveyor type (e.g., over/under, surface, etc.). In the detailed description that follows, like element numerals are used to describe like elements shown in one or more of the figures.

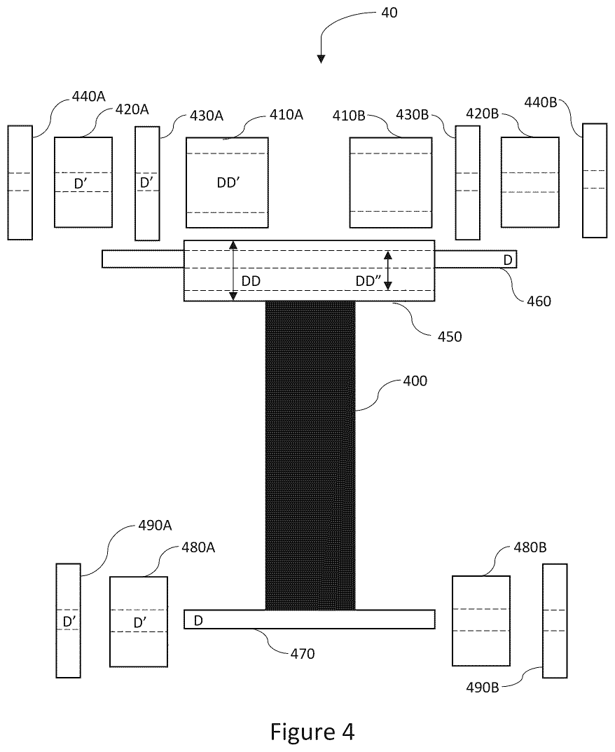

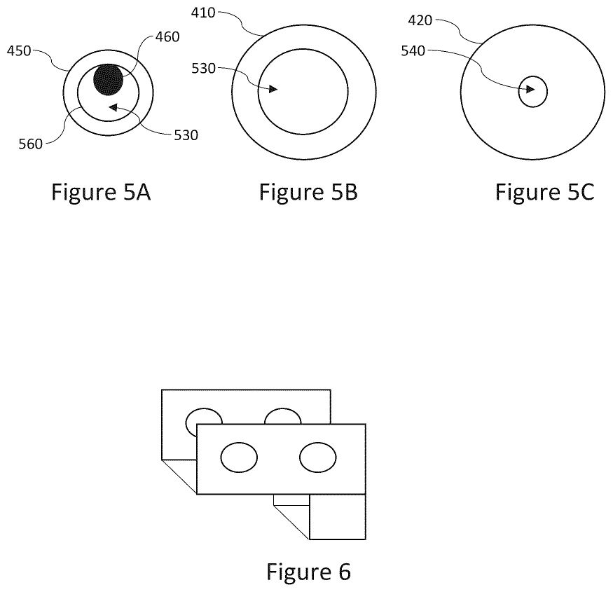

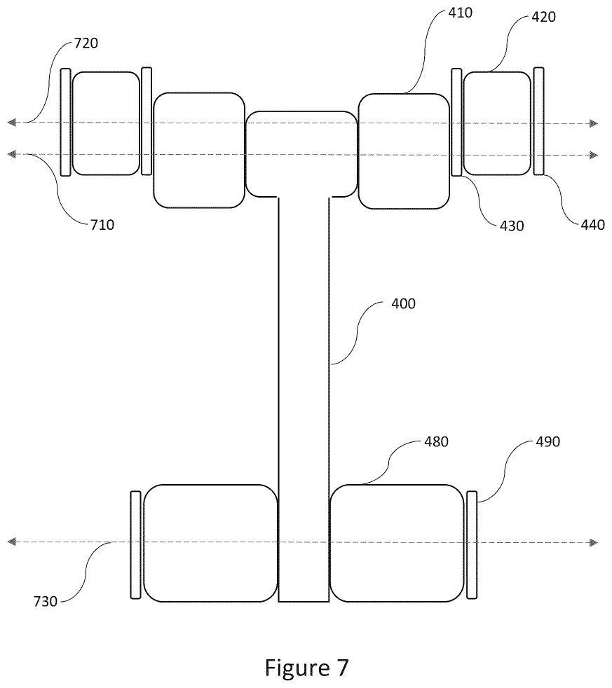

FIG. 4 depicts a roller assembly 40 in accordance with a first embodiment of the present invention. In this embodiment, the roller assembly 40 includes a body 400 having a proximate end and a distal end, wherein the proximate end is connected to a tube 450 having an outer diameter DD and an inner diameter DD″. A rod 460 having an outer diameter D is affixed to an inner surface of the tube 450. In other words, as shown in FIG. 5A, the rod 460 is placed within an aperture 530 of the tube 450 and affixed (e.g., welded) to an inner surface 560 thereof. In a preferred embodiment, the rod 460 is affixed to the tube 450 via at least one metal welded. However, the present invention is not so limited, and other ways of securing the rod to the tube are within the spirit and scope of the present invention, including a liquid adhesive (e.g., epoxy, liquid metal, etc.), bolts, rivets, straps, and all other attachment means generally known to those skilled in the art.

As show in FIGS. 4, 5B, and 5C, the roller assembly 40 further includes a first roller 410 having an aperture 530 and a second roller 420 having an aperture 540, wherein the aperture 530 has a diameter DD′ and the aperture 540 has a diameter D′. In one embodiment, the diameter DD′ is substantially the same as (e.g., slightly larger than) the diameter DD, and the diameter D′ is substantially the same as (e.g., slightly larger than) the diameter D, thereby allowing the first roller 410A to be slid over a first end of the tube 450 and the second roller 420A to be slid over a first end of the rod 460.

In operation, this allows the first roller 410A to rotate around the tube 450 and the second roller 420A to rotate (independently) around the rod 460. Not only are the rollers independent, but because the rod 450 is offset with respect to the tube 460, the rollers are as well. This can be seen in FIG. 7, showing an assembled version of the roller assembly 40. Because of the foregoing, the first roller has an axis of rotation 710 that is offset from the second roller's axis of rotation 720. This allows the first roller to come into contact with a first surface (e.g., an upper surface of a track) and the second roller to come into contact with a second surface (e.g., a vehicle's tire). While the diameters of each roller are preferably similar (or the same), other diameters are within the spirit and scope of the present invention, as long as the different diameters do not eliminate (or interfere) with the offset discussed above.

In alternate embodiments, the roller assembly 40 may further include a second pair of rollers 410B, 420B configured to slide over and rotate about a second end of the tube 450 and rod 460, respectively. In order to reduce friction between the first rollers (410A, 410B) and second rollers (420A, 420B), the assembly 40 may further include at least one washer (430A, 430B) having an aperture D′. In another embodiment, the assembly 40 may further (or alternatively) include at least one other washer (440A, 440B) having an aperture D′ for securing the second roller (420A, 420B) in place (e.g., preventing the second roller from sliding off the rod). The washer itself can be secured to the rod via a metal weld or some other form of affixation (e.g., thread/nut, etc.). Alternative, the washers 440A, 440B may have no aperture, or an aperture smaller than D′ (e.g., smaller than the diameter of the rod 460), and affixed to the ends of rod 460 (e.g., welded to the vertical end portions of rod 460). The same may be applied to the second and third embodiments, discussed below.

In yet another embodiment, the roller assembly 40 may further include a third pair of rollers 480A, 480B configured to slide over and rotate about a shaft 470 connected to a distal end of the body 400. While the shaft is shown as having a diameter D, and the third pair of rollers 480A, 480B are shown having diameters D′, other diameters that are substantially the same (e.g., one slightly larger than the other) are within the spirit and scope of the present invention. As discussed above, at least one washer (490A, 490B) may be used to secure the third pair of rollers in place (e.g., preventing the third pair of rollers from sliding off the rod).

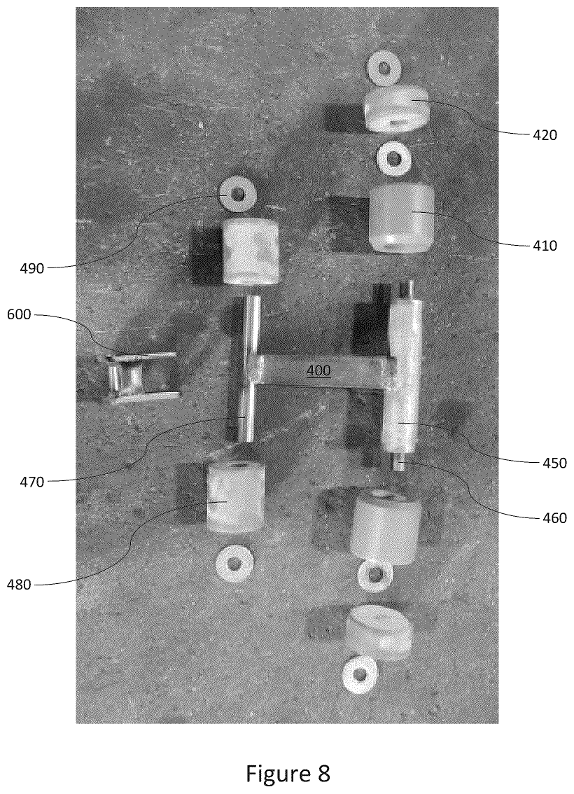

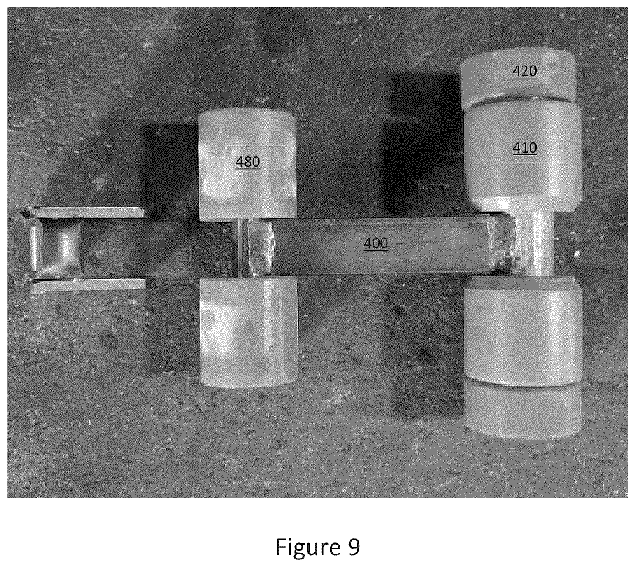

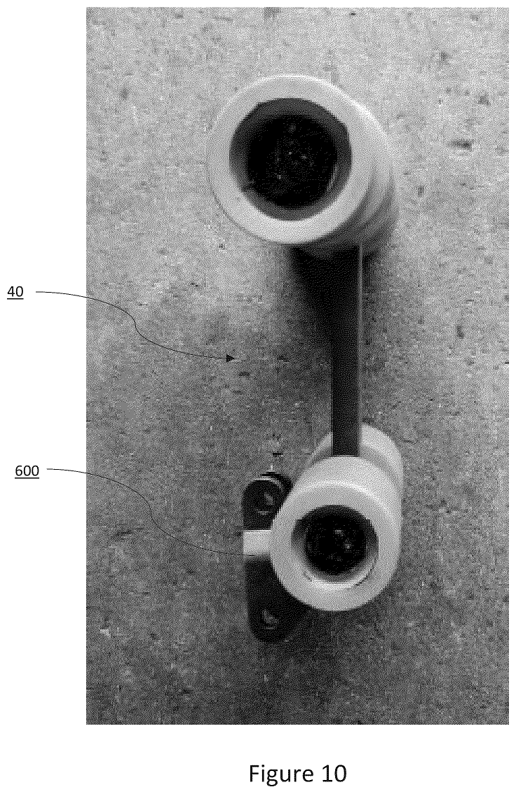

To further understand features of the foregoing embodiment, FIGS. 4 and 8 show exploded views of the assembly 40, FIGS. 7 and 9 shown assembled views of the assembly 40, and FIG. 10 shows a side view of the assembly 40. The side view further shows the linkage assembly 600 that allows the roller assembly to be connected to a car wash conveyor, or a chain-driven portion thereof. The linkage assembly 600 can further, and perhaps better, be seen in FIGS. 6, 8, and 9.

It should be appreciated that the present invention is not limited to the roller and/or linkage assembly shown in FIGS. 4-10. For example, an assembly that includes fewer, more, and/or different components is within the spirit and scope of the present invention. For example, an assembly that does not include washers, includes additional rollers, and/or a different linkage assembly (e.g., for a different conveyor system) is within the spirit and scope of the invention. By way of another example, the tube, rod, and/or shaft can be a single structure having first and second ends (e.g., configured to mate with first and second pairs of rollers, respectively), or could be separate structures (e.g., a first tube/rod for a first pair of rollers, a second tube/rod for a second pair of rollers, etc.).

It should also be appreciated that the components can be made from varying materials. For example, the body, tube, rod, and washer may be constructed from one or more metals (e.g., alloy steel, stainless steel, iron, brass, etc.) and the rollers may be constructed from plastic, rubber, etc. It should further be appreciated that while it is advantageous for certain rollers to have the same outer diameter, such is not a limitation of the present invention. For example, the first rollers (e.g., 410A, 410B) may have a first outer diameter, the second (e.g., 420A, 420B) may have a second outer diameter (e.g., a larger or smaller), etc. Other modifications (e.g., washers having a diameter DD′, the first roller coming into contact with a first surface, the second roller coming into contact with a second surface, etc.) are within the spirit and scope of the present invention.

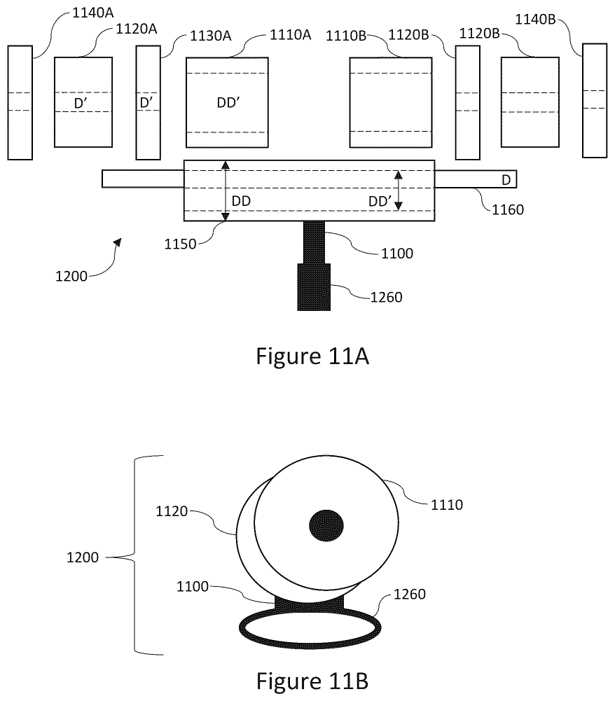

FIGS. 11A, 11B, and 12 depict a roller assembly 1200 in accordance with a second embodiment of the present invention. In this embodiment, like the previous embodiment, the roller assembly 1200 includes a body 1100 having a proximate end and a distal end, wherein the proximate end is connected to a tube 1150 having an outer diameter DD and an inner diameter DD″. A rod 1160 having an outer diameter D is affixed (e.g., via a metal weld, etc.) to an inner surface of the tube 1150. This can be seen in FIG. 12.

In particular, the roller assembly 40 further includes a first roller 1110A having an inner diameter DD′ and a second roller 1120A having an inner diameter D′. As in the other embodiment, the diameter DD′ is substantially the same as (e.g., slightly larger than) the diameter DD, and the diameter D′ is substantially the same as (e.g., slightly larger than) the diameter D. The first roller 1110A can then be slide over a first end of the tube 1150 and the second roller 1120A can then be slide over a first end of the rod 1160. In operation, this allows the first roller 1110A to rotate around the tube 1150 and the second roller 1120A to rotate (independently) around the rod 1160. Not only are the rollers independent, but because the rod 1150 is offset with respect to the tube 1160, the rollers are as well (i.e., the first roller has an axis of rotation that is different from the second roller) (see, e.g., FIGS. 11B and 12). This allows the first roller 1110A to come into contact with a first surface (e.g., an upper surface of a track) and the second roller 1120A to come into contact with a second surface (e.g., a vehicle's tire).

In alternate embodiments, the roller assembly 1200 may further include a second pair of rollers 1110B, 1120B configured to slide over and rotate about a second end of the tube 1150 and rod 1160, respectively. In order to reduce friction between the first rollers (1110A, 1110B) and second rollers (1120A, 1120B), the assembly 1200 may 1200 may further include at least one washer (1130A, 1130B) having an aperture D′. In another embodiment, the assembly 1200 may further (or alternatively) include at least one other washer (1140A, 1140B) having an aperture D′ for securing the second roller (1120A, 1120B) in place (e.g., preventing the second roller from sliding off the rod).

As shown in FIGS. 11A, 11B and 12, the body 1110 further includes a distal end connected to a linkage assembly 1260, which is configured to connect the roller assembly to a particular type of conveyor system, or more particularly a chain-driven portion thereof. It should be appreciated that the present invention is not limited to the roller assembly depicted in FIGS. 11A, 11B, and 12, and assemblies having fewer, additional, and/or different components (as discussed above with respect to the first embodiment) are within the spirit and scope of the present invention. Other modifications and configurations (e.g., shape, size, and construction of the various components, including the materials from which they are constructed), are also within the spirit and scope of the present invention.

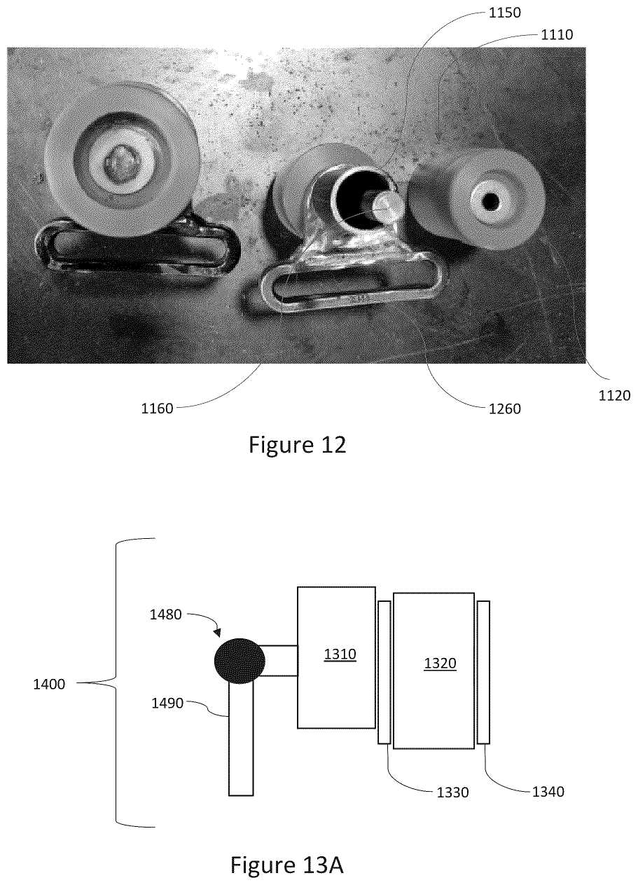

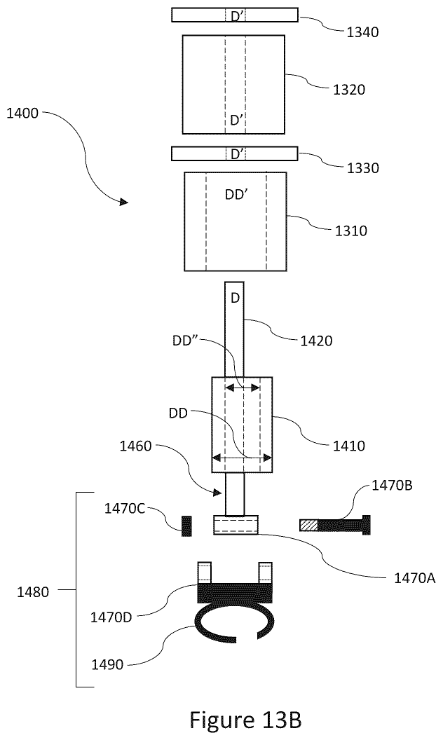

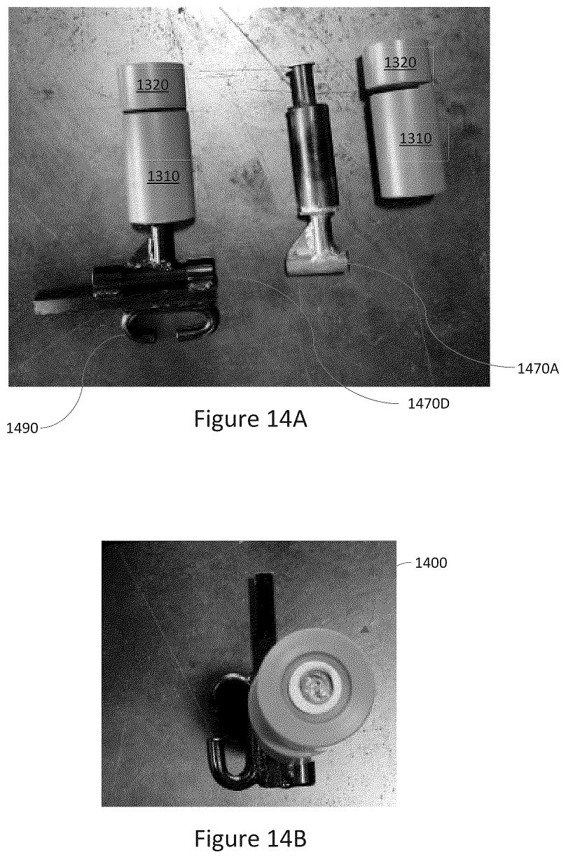

FIGS. 13A, 13B, 14A and 14B depict a roller assembly 1400 in accordance with a third embodiment of the present invention. In this embodiment, like previous embodiments, the roller assembly 1400 includes a body 1460 having a proximate end and a distal end, wherein the proximate end is connected to a tube 1410 having an outer diameter DD and an inner diameter DD″. A rod 1420 having an outer diameter D is affixed (e.g., via a metal weld, etc.) to an inner surface of the tube 1410.

The roller assembly 1400 further includes a first roller 1310 having an inner diameter DD′ and a second roller 1320 having an inner diameter D′. As in the other embodiments, diameter DD′ is substantially the same as (e.g., slightly larger than) diameter DD, and diameter D′ is substantially the same as (e.g., slightly larger than) diameter D. This allows the first roller 1310 to be slid over a first end of the tube 1410 and the second roller 1320 over a first end of the rod 1420. In operation, the first roller 1310 is then configured to rotate around the tube 1410 and the second roller 1320 is configured to rotate (independently) around the rod 1420. Not only are the rollers independent, but because the rod 1420 is offset with respect to the tube 1410, the rollers are as well (i.e., the first roller has an axis of rotation that is different from the second roller) (see, e.g., FIG. 14B). This allows the first roller 1410 to only come into contact with a first surface (e.g., an upper surface of a track) and the second roller 1420 to only come into contact with a second surface (e.g., a vehicle's tire).

It should be appreciated that the body 1460 and the rod 1420 may be separate components (e.g., physically separate structures). Alternatively, a second end of the rod 1420 may function as the body 1460, where the first end of the rod 1420 is disposed inside the second roller 1320. Both embodiments are within the spirit and scope of the present invention.

In alternate embodiments, the roller assembly 1400 may further include at least one washer (1330, 1340) having an aperture D′ (e.g., to reduce friction between the two rollers, to prevent the second roller from sliding off the rod, etc.). In yet another embodiment, the distal end of the body 1420 may further be connected to a linkage assembly 1480, which may include a “link” 1490 that is designed for connection with a surface conveyor system. Because of this, the rollers may need to pivot with respect to the linkage to remain horizontal, or parallel to the floor (or track portion thereof). Thus, a pivot is provided, which may be constructed using a pivot-hinge comprising first and second portions 1470A, 1470D configured for connection to one another (e.g., via a bolt/nut 1470B/C, pin/cotter pin, etc.). Obviously, other pivot designs are within the spirit and scope of the present invention.

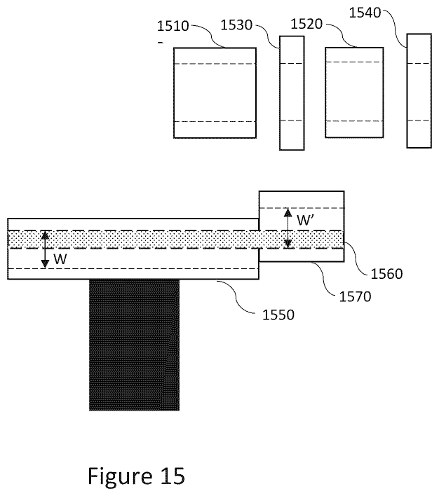

It should be appreciated that the present invention is not limited to the roller assembly depicted in FIGS. 14A, 14B, 15A and 15B, and assemblies having fewer, additional, and/or different components (as discussed above with respect to the first embodiment) are within the spirit and scope of the present invention. Other modifications and configurations (e.g., shape, size, and construction of the various components, including the materials from which they are constructed), are also within the spirit and scope of the present invention.

For example, the present invention is not limited to a first roller disposed onto a first end of a tube and a second roller disposed onto a first end of a rod. As shown in FIG. 15, the purpose of the rod 1560 is to provide an offset with respect to the tube 1550 (having an inner width W), where a first roller 1510 is disposed. Thus, the first washer 1530, second roller 1520, and/or second washer 1540 may be disposed on the rod 1560 itself (as shown in the foregoing embodiments) or on a structure attached (directly or indirectly) to the rod 1560, such as a second tube 1570 (having an inner width of W′). In this embodiment the rod 1560 is attached to the inner surface of tube 1550 and the inner surface of second tube 1570. Further, the first washer 1530, second roller 1520, and/or second washer 1540 are configured to be slid over the second tube 1570. In other words, as long as a rod (or the like) is used to provide an offset as described above (e.g., via attachment to an inner surface of the tube 1550), the addition of other structures (e.g., a second tube 1570) are within the spirit and scope of the present invention.

Having thus described preferred embodiments of roller assemblies for automatic conveyorized car washes, it should be apparent to those skilled in the art that certain advantages have been achieved. It should also be appreciated that various modifications, adaptations, and alternative embodiments thereof may be made within the scope and spirit of the present invention. The invention is further defined by the following claims.

What is claimed is:

1. An apparatus for moving a vehicle through an automatic car wash, comprising:
a roller assembly comprising:
a metal body having a proximate end and a distal end;
a metal tube connected to said distal end of said metal body, said metal tube running perpendicular to said metal body and having an outer diameter and an inner diameter;
a cylindrical shaft connected to an inner surface of said metal tube, said cylindrical shaft extending from a distal end of said metal tube and having an outer diameter that is smaller than said outer diameter of said metal tube;
a first roller having an inner diameter that is substantially the same as said outer diameter of said metal tube, said first roller being configured to slide over and rotate around said metal tube; and
a second roller having an inner diameter that is substantially the same as said outer diameter of said cylindrical shaft, said second roller being configured to slide over and rotate around said cylindrical shaft; and
a linkage assembly configured to connected said roller assembly to a a conveyor system within said automatic car wash, wherein said conveyor system is configured to move the roller assembly, and therefore the vehicle, from a starting location within said automatic car wash to a finish location within said automatic car wash;
wherein said second roller is offset from said first roller, thereby allowing (i) said first roller to contact a first surface without said first surface coming into contact with said second roller and (ii) said second roller to contact a second surface without said second surface coming into contact with said first roller.

2. The apparatus of claim 1, wherein said cylindrical shaft is a solid metal rod, having no inner aperture.

3. The apparatus of claim 1, wherein said cylindrical shaft is connected to said inner surface of said metal tube via at least one metal weld.

4. The apparatus of claim 1, wherein said first roller has an outer diameter that is substantially the same as an outer diameter of said second roller.

5. The apparatus of claim 1, further comprising a first metal washer having an inner diameter that is substantially the same as said outer diameter of said cylindrical shaft, said first metal washer being configured to slide over said cylindrical shaft and, upon assembly, being disposed between said first and second rollers.

6. The apparatus of claim 5, further comprising a second metal washer having an inner diameter that is substantially the same as said outer diameter of said cylindrical shaft, said second metal washer being configured to slide over said cylindrical shaft and, upon assembly, prevent said second roller from sliding off of said cylindrical shaft.

7. The apparatus of claim 1, further comprising a third roller, wherein said metal tube has a first end and a second end, said first roller sliding over said first end and said third roller sliding over said second end.

8. The apparatus of claim 7, further comprising a fourth roller, wherein said cylindrical shaft has a first end and a second end, said second roller sliding over said first end and said fourth roller sliding over said second end.

9. The apparatus of claim 8, further comprising fifth and sixth rollers configured to slide over a metal shaft connected to a proximal end of said metal body, said metal shaft running perpendicular to said metal body.

10. The apparatus of claim 1, wherein said metal body comprises a pivot allowing said first and second rollers to pivot with respect to said linkage assembly.

11. The apparatus of claim 1, wherein one of said first and second surfaces is an outer surface of a tire on said vehicle, said tire rolling over a track within said automatic car wash.

12. The apparatus of claim 11, wherein a remaining one of said first and second surfaces is an upper surface of said track.

13. An apparatus for moving a vehicle through a car wash, comprising:
a roller assembly comprising:
a body having a proximate end and a distal end;
a tube connected to said distal end of said metal body, said tube having an outer diameter and an inner diameter;
a shaft connected to an inner surface of said tube, said shaft extending from a distal end of said tube and having an outer diameter that is smaller than said outer diameter of said tube;
a first roller having an inner diameter that is configured to slide over an outer surface of said tube, said first roller being configured to rotate about and with respect to said tube; and
a second roller having an inner diameter that is configured to slide over an outer surface of said shaft, said second roller being configured to rotate about and with respect to said shaft;
wherein said second roller is offset from said first roller, thereby allowing said first roller to contact a first surface and said second roller to contact a second surface, said second surface being different from said first surface.

14. The apparatus of claim 13, wherein said shaft is connected to said inner surface of said tube via at least one weld.

15. The apparatus of claim 13, further comprising a first washer disposed between said first and second rollers, thereby preventing said first roller from coming into contact with said second roller.

16. The apparatus of claim 15, further comprising a second washer, said second roller being disposed between said first and second washers.

17. The apparatus of claim 13, further comprising third and fourth rollers, said third roller having a rotation axis aligned with said first roller and said fourth roller having a rotational axis aligned with said second roller.

18. The apparatus of claim 17, wherein said tube has first and second ends, said first roller being configured to slide over and rotate around said first end and said third roller being configured to slide over and rotate around said second end.

19. The apparatus of claim 17, wherein said shaft has first and second ends, said second roller being configured to slide over and rotate around said first end and said fourth roller being configured to slide over and rotate around said second end.

20. The apparatus of claim 17, further comprising at least a fifth roller configured to slide over a second tube connected to a proximal end of said metal body.
